(19) United States
(12) Patent Application Publication
(10) Pub. No.: US 2015/0350185 A1
(43) Pub. Date: Dec. 3, 2015

(54) SYSTEM AND METHOD USING SINGLE ENTRY PASSKEY FOR PAIRING MULTIPLE PERIPHERAL DEVICES

(71) Applicants: Dustin Cairns, Deerfield, OH (US); Timothy Chen, Aurora, OH (US)

(72) Inventors: Dustin Cairns, Deerfield, OH (US); Timothy Chen, Aurora, OH (US)

(73) Assignee: TECHNICAL CONSUMER PRODUCTS, INC., Aurora, OH (US)

(21) Appl. No.: 14/289,170

(22) Filed: May 28, 2014

(51) Int. Cl. H04L 29/06; H04W 4/00; H04L 12/28

(52) U.S. Cl. CPC H04L 63/083; H04L 12/2816; H04W 4/008

(57) ABSTRACT

A system for pairing a plurality of peripheral devices is disclosed, and includes a portable electronic device and a plurality of peripheral devices in wireless communication with the portable electronic device. The portable electronic device includes a processor and memory. The processor is configured to execute an instruction for prompting a user to enter a passkey only once. The processor is also configured to execute an instruction which references the memory of the portable electronic device to determine if there is at least one peripheral device that is in wireless communication with the portable electronic device that is original. The processor is configured to execute an instruction for pairing the at least one peripheral device that is original together with the portable electronic device.

### TECHNICAL FIELD

The present disclosure relates generally to a system and method for pairing multiple peripheral devices, and more particularly to a system and method of pairing multiple peripheral devices to a portable electronic device by entering a passkey only once.

### BACKGROUND

Wireless lighting control systems may utilize radio frequency (RF) communication to communicate control signals to an antenna element mounted in a light fixture. For example, a user may turn on, turn off, or dim a light using wireless control. Specifically, a user may use a portable electronic device such as, for example, a smartphone or tablet computer that includes wireless control capabilities in order to communicate with the antenna element located within the lighting fixture. For example, the portable electronic device may include Bluetooth® low energy (BLE) wireless capability in order to wirelessly communicate with one or more lighting fixtures.

A home, office, or any other building typically includes many light fixtures for illumination. For security reasons, each individual lighting fixture needs to be paired to the portable electronic device before they can exchange data. Pairing occurs when one of the light fixtures and the portable electronic device become a trusted pair. To become a trusted pair, a specific discovery and authentication process should be completed. For example, the light fixtures and the portable electronic device may become a trusted pair by exchanging a protected security identification number, or passkey. Once a lighting fixture is paired with the portable electronic device, the two devices are now connected to one another. This means that the two devices may securely exchange data between one another.

Each light fixture is paired to the portable electronic device one at a time. In particular, a user manually enters the passkey associated with each and every lighting fixture one at a time in order to pair each lighting fixture with the portable electronic device. This process may be cumbersome and time consuming for a user to complete, especially if there are numerous lighting fixtures within a home or office that need to be paired with the portable electronic device. Thus, there exists a need in the art for a quicker, more efficient approach for pairing numerous peripheral devices to a portable electronic device.

### SUMMARY

In one embodiment, a system for pairing a plurality of peripheral devices is disclosed, and includes a portable electronic device and a plurality of peripheral devices in wireless communication with the portable electronic device. The portable electronic device includes a processor and memory. The processor is configured to execute an instruction for prompting a user to enter a passkey only once. The processor is also configured to execute an instruction which references the memory of the portable electronic device to determine if there is at least one peripheral device that is in wireless communication with the portable electronic device that is original. The processor is configured to execute an instruction for pairing the at least one peripheral device that is original together with the portable electronic device.

In another embodiment, a method of pairing a plurality of peripheral devices is disclosed. The method includes providing a portable electronic device and a plurality of peripheral devices in wireless communication with the portable electronic device. The portable electronic device includes a processor and memory. The method includes executing an instruction by the processor of the portable electronic device for prompting a user to enter a passkey only once. The method includes executing an instruction by the processor of the portable electronic device which references the memory of the portable electronic device to determine if there is at least one peripheral device that is in wireless communication with the portable electronic device that is original. The method includes executing an instruction by the processor of the portable electronic device for pairing the at least one peripheral device that is original together with the portable electronic device.

### BRIEF DESCRIPTION OF THE DRAWINGS

FIG. 1 is a schematic illustration of an exemplary wireless lighting control system;

FIG. 2 is a schematic illustration of a portable electronic device and an array of lighting fixtures shown in FIG. 1;

FIG. 3 is an illustration of a graphic prompting a user for a passkey;

FIG. 4 is an illustration of a graphic showing a menu;

FIG. 5 is an alternative embodiment of the wireless lighting control system shown in FIG. 1;

FIG. 6 is an alternative embodiment of the graphic shown in FIG. 4, where the menu prompts a user for a second passkey; and

FIG. 7 is an exemplary process flow diagram illustrating an exemplary method of controlling the lighting fixtures shown in FIG. 2.

### DETAILED DESCRIPTION

The following detailed description will illustrate the general principles of the invention, examples of which are additionally illustrated in the accompanying drawings. In the drawings, like reference numbers indicate identical or functionally similar elements.

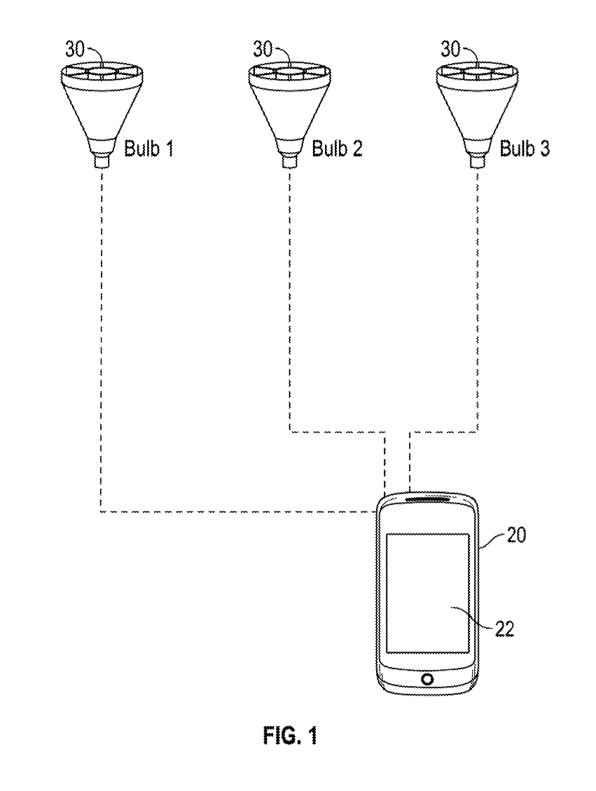

FIG. 1 is an exemplary schematic illustration of a wireless lighting control system 10. The wireless lighting control system 10 may include a portable electronic device 20 in wireless communication with a plurality of lighting fixtures 30. Specifically, each lighting fixture 30 may be part of an array. For example, in the embodiment as shown, an array 32 represents a plurality of lighting fixtures 30 located in a specific room of a home or office that may be controlled using the portable electronic device 20. For example, in one approach, the array 32 could be all of the lighting fixtures 30 in a user's bedroom. Those skilled in the art will readily appreciate that the illustration in FIG. 1 is merely an illustrative example of the wireless lighting control system 10, and that any number of lighting fixtures 30 may be located within the array 32.

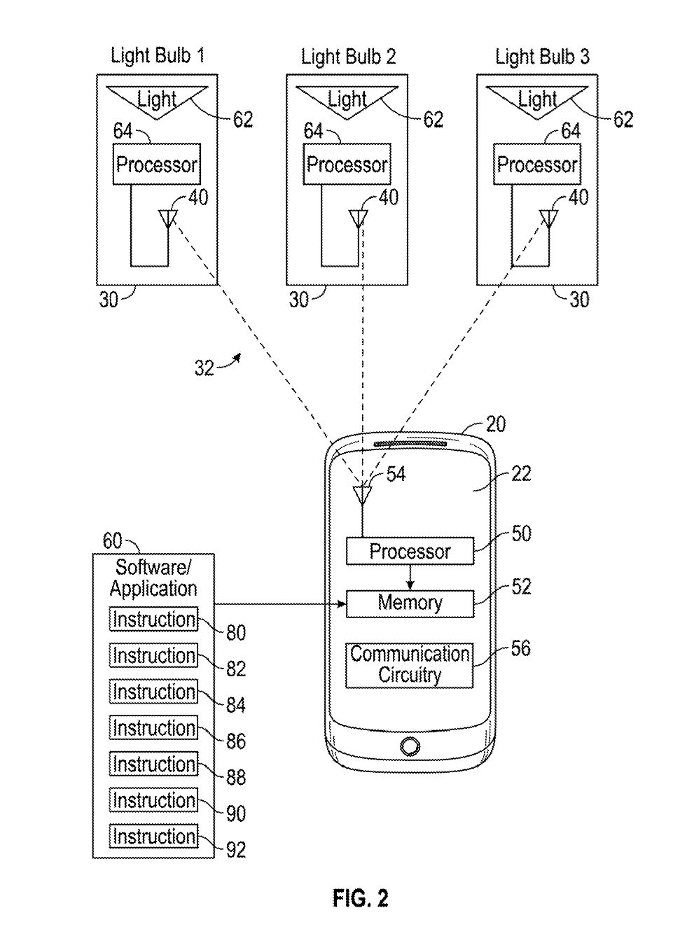

In one embodiment, the lighting fixtures 30 may each by any type of illumination device for emitting visible light, which includes an antenna element 40 (shown in FIG. 2) that is configured to send and receive radio frequency (RF) signals. For example, in one embodiment the antenna element 40 may be configured to send and receive a short-range RF signal such as, for example, a Bluetooth® low energy (BLE) signal. The lighting fixtures 30 may be any type of lighting fixture configured to emit visible light such as, but not limited to, an LED lamp, an incandescent lamp, a compact fluorescent lamp (CFL), or a gas-discharge lamp.

The portable electronic device 20 may be any type of portable electronic device that sends and receives RF signals. In particular, in one embodiment the portable electronic device 20 may be configured to wirelessly connect with the lighting fixtures 30 using a short-range RF signal, such as a BLE signal. The portable electronic device 20 may be, for example, a smartphone, a tablet, a laptop computer, a personal computer or a vehicle such as an automobile. The portable electronic device 20 may include a user interface that allows a user to enter input. The portable electronic device 20 may also include a display that generates an image visible to the user. In the embodiment as shown, the user interface and display are combined with one another as a touchscreen 22. However, it is to be understood that the embodiment as illustrated in the figures is merely exemplary in nature, and that a separate user interface and display may be used as well.

The portable electronic device 20 may be a master device that is used to control the lighting elements 30. For example, the portable electronic device 20 may be used to control the color (e.g., red, blue, or green lighting), dimming, or power to the lighting elements 30. Those skilled in the art will appreciate that although FIG. 1 illustrates a wireless lighting control system 10, the disclosure is not limited to lighting fixtures. Instead, the portable electronic device 30 may be used to control any type of wireless peripheral devices in an array. For example, in one embodiment, the portable electronic device 20 may be used to control a speaker system having multiple speakers.

Turning now to FIG. 2, the portable electronic device 20 includes a processor 50, memory 52, an antenna element 54 and communications circuitry 56. When the portable electronic device 20 is in operation, the processor 50 executes instructions stored within the memory 52, to communicate data to and from the memory 52, and to generally control operations of the portable electronic device 20 pursuant to the instructions. A processor may be any custom made or commercially available processor, a central processing unit (CPU), or generally any device for executing instructions.

The antenna element 54 may be in signal communication with the processor 50. Similar to the antenna element 40 of the lighting fixtures 30, the antenna element 54 may also be configured to receive a short-range RF signal such as, for example, a BLE signal. The communications circuitry 56 may be any type of circuitry operative to connect to a communications network and to transmit communications (e.g., data) from the portable electronic device 20 to other devices within a communications network.

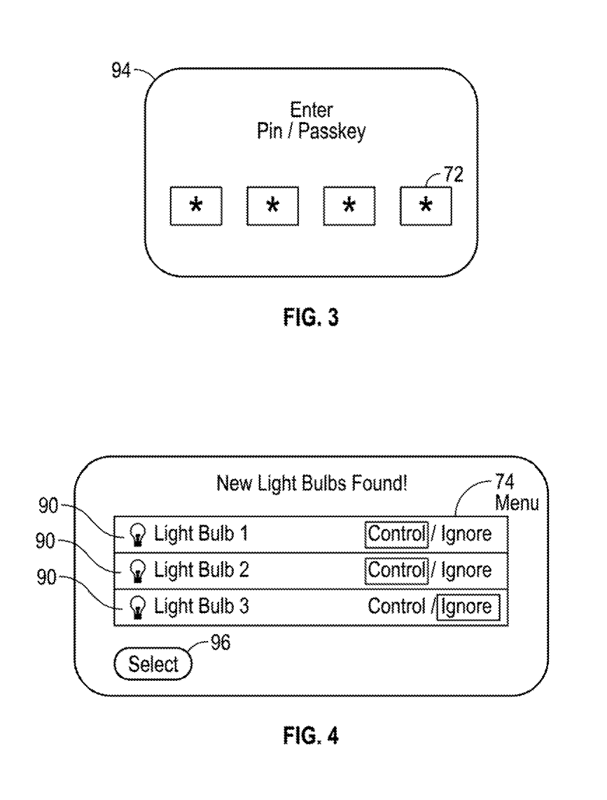

In one embodiment, an application or software 60 may be downloaded into the memory 52 of the portable electronic device 20. The software 60 may be used to enable wireless control of the lighting fixtures 30 by the portable electronic device 20. Specifically, the software 60 may be used to pair each of the lighting fixtures 30 with the portable electronic device 20 using a single security identification number, which is also referred to as a passkey 72 (illustrated in FIG. 3). For example, in one embodiment the passkey 72 may be a four-digit number. The software 60 may also be used to ensure that multiple prompts do not repeatedly appear upon the touchscreen 22 requesting a user to enter the passkey 72 as each of the lighting fixtures 30 within the array 32 are paired to the personal electronic device 20.

FIG. 2 also illustrates each of the lighting fixtures 30 located within the first array 32. Each lighting fixture 30 includes one or more lighting elements 62, a processor 64, and the antenna element 40. The processor 64 may be in signal communication with the antenna element 40 and the lighting elements 62. The processor 64 may be used to control and deliver power to the lighting elements 62. The lighting elements 62 may be any type of device that generates visible light such as, for example, one or more a light emitting diodes (LEDs) or a filament of an incandescent light.

The processor 64 of each lighting fixture 30 may be in communication with the portable electronic device 20 through a wireless connection 70. As discussed above, in one embodiment the wireless connection 70 may be any type of short-range RF connection such as, for example, BLE. At any given time, a specific one of the antenna elements 40 of one of the lighting fixtures 30 and the antenna element 54 of the portable electronic device 20 may be connected to one another through the wireless connection 70. It is to be understood that before the wireless connection 70 is established between a lighting fixture 30 and the portable electronic device 20, each lighting fixture 30 may need to be paired to the portable electronic device 20 first. Pairing occurs when one of the light fixtures 30 and the portable electronic device 20 become a trusted pair, where a specific discovery and authentication process are completed. For example, each lighting fixture 30 and the portable electronic device 20 may become a trusted pair by exchanging the passkey 72 (shown in FIG. 3).

The software 60 stored in the memory 52 of the portable electronic device 20 may include instructions for wirelessly connecting with and pairing to one or more of the lighting fixtures 30 within the array 32, while only prompting a user for the passkey 72 once. As described in greater detail below, the software 60 stored in the memory 52 of the portable electronic device 20 may include a plurality of instructions 80, 82, 84, 86, 88, 90 and 92 stored therein that are executable by the processor 50. Specifically, the processor 50 of the portable electronic device 20 may execute instruction 80 for prompting a user to enter the passkey 72. It should be noted that a user may only need to enter the passkey 72 once, even if multiple lighting fixtures 30 need to be paired with the portable electronic device 20.

Once the passkey 72 has been entered, the processor 50 may execute instruction 82 for wirelessly connecting with a selected lighting fixture 30, and determines whether the selected lighting fixture has sent an advertisement or broadcast signal. The processor 50 may wirelessly connect with each lighting fixture 30 within the array 32 using round-robin scheduling, thereby receiving the broadcast signal from each lighting fixture 30. Once the portable electronic device 20 has connected with each lighting fixture 30 within the array 32, the processor 50 references the memory 52 to determine whether there are any original or new lighting fixtures 30 within the array 30.

If there are any new lighting fixtures 30 within the array, the processor 50 may execute instruction 88 that generates a menu 74 (FIG. 4) on the touchscreen 22 of the portable electronic device 20. The menu 74 allows a user to select which lighting fixtures 30 he or she would like to control. Once a user selects one or more specific lighting fixtures 30 listed in the menu 74, the processor 50 may execute instruction 90 that wirelessly connects with the lighting fixtures 30 one at a time, based on round-robin scheduling. Specifically, during a time slice the processor 50 may wirelessly connect with and send a control signal to the specific lighting fixtures 30 that the user selected using the menu 74. The control signal, which is described in greater detail below, contains the passkey 72 (FIG. 3).

The processor 64 of each of the lighting fixtures 30 may include circuitry or control logic for sending the broadcast signal over the wireless connection 70 to the processor 50 of the portable electronic device 20. In one exemplary embodiment, the broadcast signal may indicate that the lighting fixture 30 originates from a specific manufacturer. For example, the broadcast signal may indicate that the lighting fixture 30 is manufactured by Technical Consumer Products Inc., of Aurora, Ohio. Although data indicating a specific manufacturer is discussed, it is to be understood that the disclosure is not limited to a specific brand or manufacturer of the lighting fixture 30, and that other data may be used as well in the broadcast signal. In addition to the specific manufacturer, the broadcast signal also includes a device address, which may be referred to as a specific media access control address (MAC address) that is unique to the specific lighting fixture 30. The broadcast signal may also indicate the type of service being provided. For example, the lighting fixture 30 provides lighting service.

Continuing to refer to FIG. 2, once the software 60 stored in the memory 52 of the portable electronic device 20 is activated (i.e., a user opens an application that is associated with the software 60), the processor 50 of the portable electronic device 20 may execute instruction 80. Referring to FIGS. 2-3, instruction 80 generates a graphic 94 on the touchscreen 22 of the portable electronic device 20 prompting a user to enter the passkey 72. Once a user enters the passkey 72, the processor 50 of the portable electronic device 20 may execute instruction 82. Instruction 82 searches for the broadcast signal from a specific lighting fixture 30. For purposes of explanation, the processor 50 will be described as searching for the broadcast signal from Light Bulb 1. The processor 50 of the portable electronic device 20 may then execute instruction 84, which establishes a connection between Light Bulb 1 and the portable electronic device 20 using the wireless connection 70. The processor 50 of the portable electronic device 20 may also receive the broadcast signal from Light Bulb 1.

Once the wireless connection 70 between Light Bulb 1 and the portable electronic device 20 is established, the processor 50 of the portable electronic device 20 may execute instruction 86. The instruction 86 determines if the memory 52 of the portable electronic device 20 contains the unique device address or MAC address associated with Light Bulb 1. If the memory 52 of the portable electronic device 20 does not contain the MAC address associated with Light Bulb 1, this is an indication that Light Bulb 1 is an original or new lighting fixture 30. In other words, Light Bulb 1 has never been controlled by the portable electronic device 20 in the past. Alternatively, in another approach, a new light bulb could also mean that there has been a factory reset of Light Bulb 1. Factory reset occurs when the passkey 72 stored in memory of the lighting fixture 30 is reset to a default setting (e.g., the passkey 72 is reset to “1234”) and an identifier of the lighting fixture 30 is also reset to a default setting as well (e.g., the identifier is reset to “TCP Bulb”).

The processor 50 of the portable electronic device 20 may then determine if there are remaining lighting fixtures 30 in the array 32 that need to be monitored. For example, in the embodiment as shown in FIG. 2, the processor 50 of the portable electronic device 20 determines that Light Bulb 2 and Light Bulb 3 need to be monitored. Once all of the lighting fixtures 30 within the array 32 have been monitored, the processor 50 of the portable electronic device 20 may execute instruction 88. Referring to both FIGS. 2 and 4, instruction 88 compiles a list of all of the new lighting fixtures 30 within the array 32. Instruction 88 also generates a graphic representing the menu 74 upon the touchscreen 22 of the portable electronic device 20. The menu 74 is based on the new lighting fixtures 30 that were found by executing instructions 80-86. Specifically, referring to FIG. 4, the menu 74 may list each new lighting fixture 30 in the array 32. For example, in the embodiment as shown in FIG. 4, Light Bulb 1, Light Bulb 2, and Light Bulb 3 are new lighting fixtures 30.

The menu 74 may include a ‘Control/Ignore’ feature. Specifically, each new lighting fixture 30 listed in the menu 74 includes a ‘Control’ option as well as an ‘Ignore’ option. A user may select ‘Control’ if he or she wishes to control a specific lighting fixture using the portable electronic device 20. Similarly, a user may select ‘Ignore’ if he or she wishes not to control a specific lighting fixture using the portable electronic device 20. In the event the user selects ‘Ignore’ for a specific lighting fixture 30, the MAC address associated with the specific lighting fixture 30 is saved in the memory 52 of the portable electronic device 20, along with an indication that the specific lighting fixture 30 should not be prompted for control in the future. For example, if a user chooses to ignore Light Bulb 3, the MAC address associated with Light Bulb 3 is saved in the memory 52 of the portable electronic device 20. The next time Light Bulb 3 sends the broadcast signal to the portable electronic device 20, the processor 50 may execute an instruction that suppresses or blocks Light Bulb 3 from being listed in the menu 74.

Once a user is finished selecting which lighting fixtures he or she wishes to control, the user may select a graphic 96, which indicates the selections have been made. For example, in the embodiment as shown in FIG. 4, the graphic 96 is a button labelled ‘select’. If a user selects ‘Control’ for at least one of the lighting fixtures 30 listed within the menu 74, this causes the processor 50 to execute instruction 90. Instruction 90 sends the control signal through the wireless connection 70 and to one of the lighting fixtures 30 that were selected by the user using the menu 74 shown in FIG. 4 (e.g., Light Bulb 1). The control signal may include several pieces of data, namely the MAC address of the specific lighting fixture 30 and the passkey 72. Once Light Bulb 1 receives the control signal sent by the portable electronic device 20, the processor 64 of Light Bulb 1 may save the passkey 72 within memory. Light Bulb 1 and the portable electronic device 20 are now paired to one another.

Once the processor 50 of Light Bulb 1 sends the control signal through the wireless connection 70 and to Light Bulb 1 and the time slice is complete, the processor 50 may then execute instruction 92. Instruction 92 disconnects or terminates the wireless connection 70 between the specific lighting fixture 30 and the portable electronic device 20 (e.g., Light Bulb 1). It is to be understood that since instructions 80, 82, 84, 86, 88, 90, and 92 are carried out using round-robin scheduling, if by chance any of the instructions are unable to complete within the assigned time slice, then the wireless connection 70 will still be terminated.

As soon as the wireless connection 70 is terminated, the processor 50 may then determine if there are remaining lighting fixtures 30 in the array 32 that need to be paired. For example, if a user selected Light Bulbs 1-2 to control, then the processor 50 may loop back to instruction 90, and connects with Light Bulb 2.

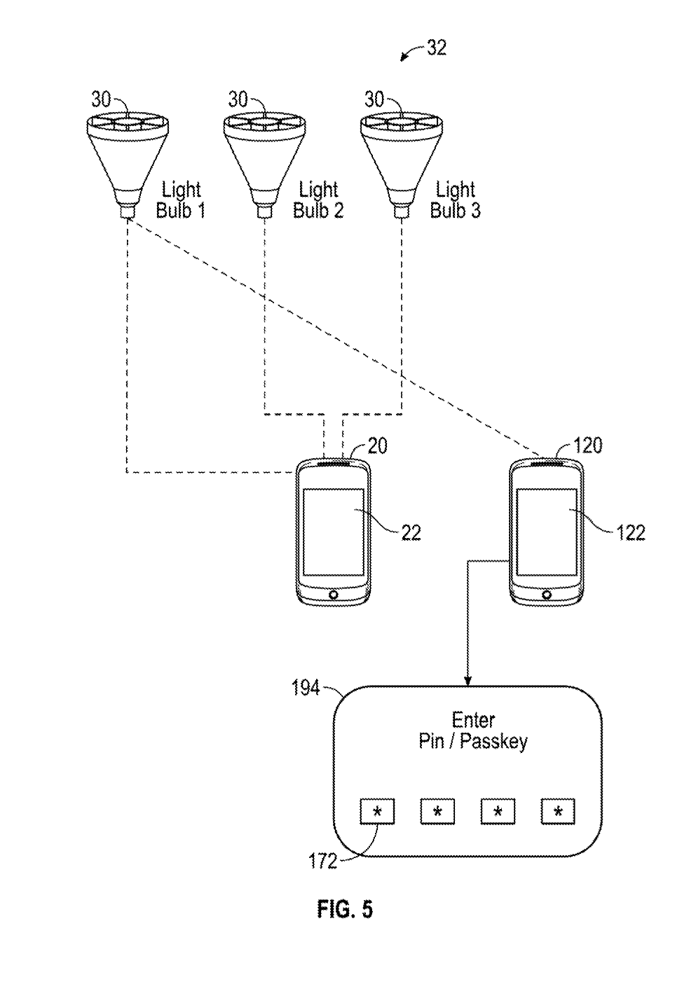

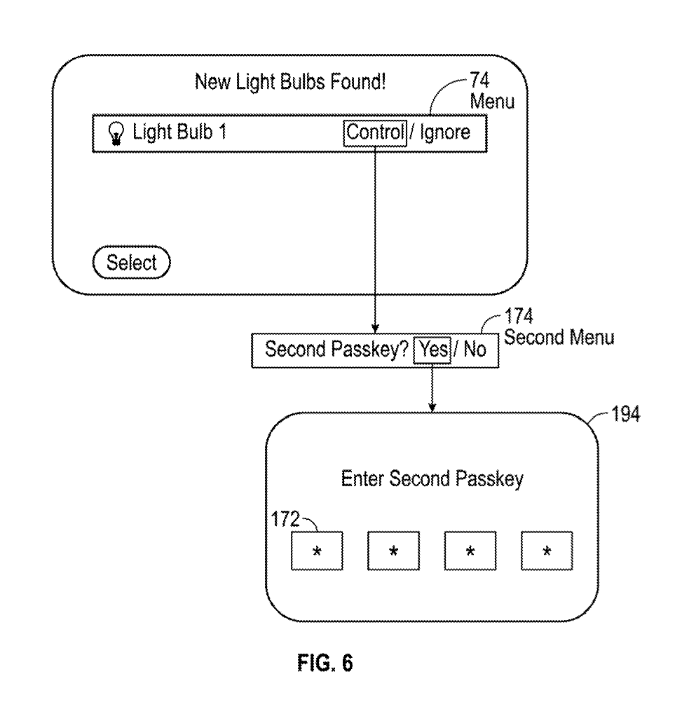

Referring to FIG. 5, in one embodiment there may be a second tier of pairing that exists between at least one of the lighting fixtures 30 and a second portable electronic device 120. The second portable electronic device 120 may be paired to one or more of the lighting fixtures 30 using a second passkey 172 (shown in FIG. 6). The second portable electronic device 120 may be another electronic device paired with at least a portion of the lighting fixtures 30 within the array 32. For purposes of explanation, the second portable electronic device 120 is illustrated and paired with Light Bulb 1.

Referring to both FIGS. 5-6, the portable electronic device 20 should first be paired with the lighting fixtures 30 before pairing the second electronic device 120 with one or more of the lighting fixture 30. As described above, as the portable electronic device 20 is paired with the lighting fixtures 30, the processor 50 (shown in FIG. 2) of the portable electronic device 20 generates the menu 74 upon the touchscreen 22. If a user selects ‘Control’ for a specific lighting fixture 30 (e.g., Light Bulb 1), then the processor 50 of the portable electronic device may execute an instruction that generates a second menu 174 upon the touchscreen 22. The second menu 174 may allow a user to select whether he or she would like to associate a second passkey (e.g., the second passkey 172) with the selected lighting fixture 30 (e.g., Light Bulb 1). If a user selects ‘Y’, then the processor 50 of the portable electronic device 20 may execute an instruction that generates a graphic 194 upon the touchscreen 22. The graphic 194 prompts a user to enter the second passkey 172.

Once the second passkey 172 is entered, the processor 50 of the portable electronic device 20 may then execute instructions 82-92 (illustrated in FIG. 2), and the portable electronic device 20 is now paired to Light Bulb 1. Moreover, both the passkeys 72, 172 have been saved to the memory of Light Bulb 1. Once both the passkeys 72, 172 have been saved to memory, a user may now pair the second portable electronic device 120 with Light Bulb 1.

In order to pair the second portable electronic device 120 with Light Bulb 1, a processor (not shown) of the second portable electronic device 120 may execute an instruction that prompts a user to enter the second passkey 172. Specifically, referring to FIG. 5, the processor of the second portable electronic device 120 generates a graphic 194 on the touchscreen 122 of the second portable electronic device 120 prompting a user to enter the second passkey 172. If a user enters the second passkey 172 correctly, then the second portable electronic device 120 may be paired with Light Bulb 1.

In an alternative approach for connecting the second portable electronic device 172 with Light Bulb 1, the processor of the second portable electronic device 120 may execute an instruction prompting a user to first enter the passkey 72. The first passkey 72 is associated with the portable electronic device 20. If the user enters the passkey 72 correctly, the processor of the second portable electronic device 120 may execute an instruction prompting a user to enter the second passkey 172. If a user enters the second passkey 172 correctly, then the second portable electronic device 120 may be paired with Light Bulb 1.

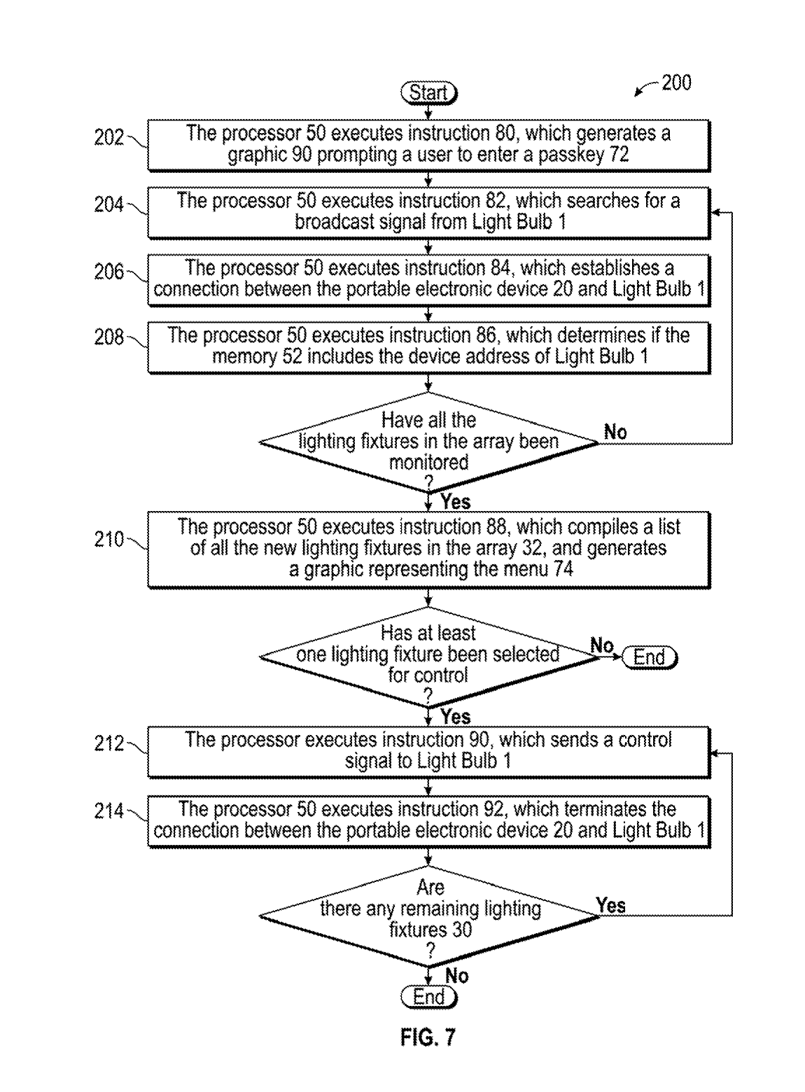

The software 60 provides a user with a less cumbersome and time consuming process for entering the passkey 72 (FIG. 3) into the portable electronic device 20. Specifically, the software 60 allows a user to enter the passkey 72 only once, even if multiple lighting fixtures 30 may need to be paired with the portable electronic device 20. Turning now to FIG. 7, an exemplary process flow diagram illustrating a method 100 of pairing the lighting fixtures 30 with the portable electronic device 20 is illustrated. Referring generally to FIGS. 1-7, the method 200 may begin at block 202, where the processor 50 of the portable electronic device 20 may execute instruction 80. Instruction 80 generates the graphic 94 on the touchscreen 22 of the portable electronic device 20 prompting a user to enter the passkey 72. The method 200 may then proceed to block 204.

In block 204, the processor 50 of the portable electronic device 20 may execute instruction 82. Instruction 82 searches for the broadcast signal from the specific lighting fixture 30 (e.g., Light Bulb 1). The method 200 may then proceed to block 206.

In block 206, the processor 50 of the portable electronic device 20 may then execute instruction 84, which establishes a connection between Light Bulb 1 and the portable electronic device 20 using the wireless connection 70. The processor 50 of the portable electronic device 20 may also receive the broadcast signal from Light Bulb 1. The method 200 may proceed to block 208.

In block 208, the processor 50 of the portable electronic device 20 may execute instruction 86. The instruction 86 determines if the memory 52 of the portable electronic device 20 contains the unique MAC address associated with Light Bulb 1. The processor 50 of the portable electronic device 20 may then determine if all of the lighting fixtures 30 within the array 32 have been monitored. If there are remaining lighting fixtures 30 that still need to be monitored (e.g., Light Bulbs 2-3), then the method 200 may return to block 204. However, if there are no more lighting fixtures 30 within the array 32 that need monitoring, then the method 200 may then proceed to block 210.

In block 210, the processor 50 of the portable electronic device 20 may execute instruction 88. Instruction 88 compiles a list of all of the new lighting fixtures 30 within the array 32. Instruction 88 also generates the graphic representing the menu 74 upon the touchscreen 22 of the portable electronic device 20. Referring to FIG. 4, if a user selects ‘Control’ for at least one of the lighting fixtures 30 listed within the graphic 92, then the method 200 may proceed to block 212. If a user does not select ‘Control’ for at least one lighting element 30, then the method 200 may terminate.

In block 212, the processor 50 executes instruction 90. Instruction 90 sends the control signal through the wireless connection 70 and to one of the lighting fixtures 30 that were selected by the user using the menu 74 shown in FIG. 4 (e.g., Light Bulb 1). The method 200 may then proceed to block 214.

In block 214, the processor 50 may execute instruction 92. Instruction 92 disconnects or terminates the wireless connection 70 between the specific lighting fixture 30 and the portable electronic device 20 (e.g., Light Bulb 1). As soon as the wireless connection 70 is terminated, the processor 50 may then determine if there are remaining lighting fixtures 30 that need to be paired. If there are remaining lighting fixtures 30, then the processor 50 may loop back to block 212, and connects with another lighting fixture 30 located within the first array 32. However, if there are no other lighting fixtures 30 that need to be paired, then method 200 may terminate.

Referring generally to FIGS. 1-7, the disclosed wireless lighting control system 10 may provide a user with a quicker, more efficient approach for pairing numerous lighting fixtures to the portable electronic device. Specifically, unlike the current approach that is used today, the disclosed lighting system may wirelessly connect and pair to one or more of the lighting fixtures within the array with the portable electronic device, while only prompting a user for the passkey once. In one embodiment, the disclosed wireless lighting control system 10 may allow for a user to pair a second portable electronic device with one or more of the lighting fixtures within the array as well.

While the forms of apparatus and methods herein described constitute preferred embodiments of this invention, it is to be understood that the invention is not limited to these precise forms of apparatus and methods, and the changes may be made therein without departing from the scope of the invention.

What is claimed is:

1. A system for pairing a plurality of peripheral devices, comprising:
a portable electronic device and a plurality of peripheral devices in wireless communication with the portable electronic device, wherein the portable electronic device includes a processor and memory, the processor configured to:
execute an instruction for prompting a user to enter a passkey only once;
execute an instruction which references the memory of the portable electronic device to determine if there is at least one peripheral device that is in wireless communication with the portable electronic device that is original; and
execute an instruction for pairing the at least one peripheral device that is original together with the portable electronic device.

2. The system of claim 1, wherein the processor is configured to execute an instruction for searching for a broadcast signal transmitted from a selected one of the plurality of peripheral devices.

3. The system of claim 2, wherein the broadcast signal includes a device address that is unique to the selected one of the plurality of peripheral devices.

4. The system of claim 3, wherein the processor references the memory for the device address in order to determine if there is at least one peripheral device that is original.

5. The system of claim 2, wherein the processor is configured to execute an instruction to send a control signal to the selected one of the plurality of peripheral devices.

6. The system of claim 5, wherein the control signal includes a device address that is unique to the selected one of the plurality of peripheral devices, and the passkey.

7. The system of claim 2, wherein the processor is configured to execute an instruction to terminate the connection between the portable electronic device and the selected one of the plurality of peripheral devices.

8. The system of claim 1, wherein the processor further includes a display.

9. The system of claim 8, wherein the processor is configured to execute an instruction that generates a graphic on the display, wherein the graphic represents a menu that lists the at least one peripheral device that is original.

10. The system of claim 1, wherein the processor is configured to execute an instruction that prompts a user to enter a second passkey.

11. The system of claim 10, wherein the second passkey is associated with a second portable electronic device, and wherein the second portable electronic device is paired with at least one of the plurality of peripheral devices.

12. The system as recited in claim 1, wherein the plurality of peripheral devices are lighting fixtures.

13. The system as recited in claim 1, wherein the portable electronic device is one of a smartphone, a tablet, a laptop computer, a personal computer or a vehicle.

14. The system as recited in claim 1, wherein the passkey is a four digit number.

15. A method of pairing a plurality of peripheral devices, the method comprising:
providing a portable electronic device and a plurality of peripheral devices in wireless communication with the portable electronic device, wherein the portable electronic device includes a processor and memory;
executing an instruction by the processor of the portable electronic device for prompting a user to enter a passkey only once;
executing an instruction by the processor of the portable electronic device which references the memory of the portable electronic device to determine if there is at least one peripheral device that is in wireless communication with the portable electronic device that is original; and
executing an instruction by the processor of the portable electronic device for pairing the at least one peripheral device that is original together with the portable electronic device.

16. The method of claim 15, comprising executing an instruction by the processor of the portable electronic device for searching for a broadcast signal transmitted from a selected one of the plurality of peripheral devices.

17. The method of claim 16, wherein the broadcast signal includes a device address that is unique to the selected one of the plurality of peripheral devices.

18. The method of claim 15, wherein the processor further includes a display.

19. The method of claim 18, comprising executing an instruction by the processor of the portable electronic device that generates a graphic on the display, wherein the graphic represents a menu that lists the at least one peripheral device that is original.

20. The method of claim 15, comprising executing an instruction by the processor of the portable electronic device that prompts a user to enter a second passkey.
